(19) United States
(12) Patent Application Publication
(10) Pub. No.: US 2023/0221222 A1
(43) Pub. Date: Jul. 13, 2023

(54) AUTOMATED TISSUE SECTION SYSTEM WITH THICKNESS CONSISTENCY CONTROLS

(71) Applicant: Clarapath, Inc., Hawthorne, NY (US)

(72) Inventors: Partha P. Mitra, New York, NY (US); Aaron Ames, Hawthorne, NY (US); Baris Yagci, Montclair, NY (US); Robert Shusko, Merrick, NY (US); Robert Chen, Hawthorne, NY (US)

(73) Assignee: Clarapath, Inc., Hawthorne, NY (US)

(21) Appl. No.: 17/992,894

(22) Filed: Nov. 22, 2022

Related U.S. Application Data
(60) Provisional application No. 63/264,383, filed on Nov. 22, 2021.

(51) Int. Cl. G01N 1/31; G01N 1/06

(52) U.S. Cl. CPC G01N 1/312; G01N 1/06; G01N 2001/315; G01N 2001/061

(57) ABSTRACT

A microtomy system includes a tissue chuck configured to accept a tissue block and a microtome blade configured to remove one or more tissue sections from the tissue block, the microtome blade being axially offset from the tissue chuck along a horizontal axis, where the microtome blade and the tissue chuck are axially displaceable relative to one another along the horizontal axis. The system also includes a control system configured to receive information indicative of a relative axial location of the microtome blade to the tissue chuck along the horizontal axis, and to use a control loop to control the relative axial location of the microtome blade to the tissue chuck such that the one or more tissue sections have a desired thickness.

### CROSS-REFERENCE TO RELATED APPLICATIONS

This application claims the benefit of priority to U.S. Provisional Patent Application No. 63/264,383, filed Nov. 22, 2021, which is incorporated herein by reference in its entirety.

### FIELD

The present disclosure relates to automated systems and methods for sectioning tissue from biological tissue blocks.

### BACKGROUND

Traditional microtomy, the production of micron-thin tissue sections for microscope viewing, is a delicate, time consuming manual task. Recent advancements in the digital imaging of tissue sample sections have made it desirable to slice blocks of specimen very quickly. By way of example, where tissues are sectioned as part of clinical care, time is an important variable in improving patient care. Every minute that can be saved during sectioning of tissue for intra-operative applications of anatomic pathology, for example in examining margins of lung cancers to determine whether enough tissue has been removed, is of clinical value. To create a large number of sample sections quickly, it is desirable to automate the process of cutting tissue sections from the supporting tissue block by a microtome blade and facilitating the transfer of cut tissue sections to slides.

Every minute that can be saved during sectioning of tissue for intra-operative applications of anatomic pathology, can be critical. It would be advantageous to provide an automated system which can increase the tissue sectioning consistency, saving time.

### SUMMARY

There is a need for improvements of systems and methods for preparation of consistent tissue samples. The present disclosure is directed toward solutions to address this need, in addition to having other desirable characteristics.

The present disclosure relates to a microtomy system including: a tissue chuck configured to accept a tissue block; a microtome blade configured to remove one or more tissue sections from the tissue block, the microtome blade being axially offset from the tissue chuck along a horizontal axis, wherein the microtome blade and the tissue chuck are axially displaceable relative to one another along the horizontal axis; and a control system configured to receive information indicative of a relative axial location of the microtome blade to the tissue chuck along the horizontal axis, and to use a control loop to control the relative axial location of the microtome blade to the tissue chuck such that the one or more tissue sections have a desired thickness.

In some embodiments, the present disclosure relates to a microtomy system further including: one or more position sensors configured to collect information indicative of the relative axial location of the microtome blade to the tissue chuck and to communicate the relative axial location to the control system; and an actuator, in communication with the control system, configured to displace the tissue chuck along the horizontal axis. In some embodiments, the present disclosure relates to a microtomy system, wherein the control system further includes one or more position sensors to measure an axial location of the tissue chuck and an axial location of the microtome blade along the horizontal axis. In some embodiments, the present disclosure relates to a microtomy system further including: an axial actuator coupled the tissue chuck to axially displace the tissue chuck, wherein the control system is configured to actuate the axial actuator to displace the tissue chuck as a function of the relative axial location of the microtome blade to the tissue chuck. In some embodiments, the present disclosure relates to a microtomy system further including: a series of elastic actuators for clamping the microtome blade that has an anisotropic structure so that it can provide high clamping forces on the microtome blade and conform to an opposing clamping plate—blade system in another direction while dissipating energy to passively control vibrations of the microtome blade. In some embodiments, the present disclosure relates to a microtomy system further including: one or more force sensors configured to collect information indicative of the relative axial location of the microtome blade to the tissue chuck and to communicate the relative axial location to the control system; and an actuator, in communication with the control system, configured to displace the tissue chuck along the horizontal axis. In some embodiments, the present disclosure relates to a microtomy system further including one or more force sensors positioned on the tissue chuck and configured to determine a force applied to the tissue block from the microtome blade. In some embodiments, the present disclosure relates to a microtomy system, wherein the information indicative of the relative axial location is a force applied to the tissue block from the microtome blade. In some embodiments, the present disclosure relates to a microtomy system, further including an actuator, in communication with the control system, configured to displace the tissue chuck along a vertical axis. In some embodiments, the present disclosure relates to a microtomy system, wherein the actuator is coupled to a leadscrew via a non-rigid system configured to decouple the leadscrew from the actuator. In some embodiments, the present disclosure relates to a microtomy system, further including an actuator, in communication with the control system, configured to displace the tissue chuck along the horizontal axis, wherein the control loop controls the actuator to displace the tissue chuck along the horizontal axis such that the one or more tissue sections have a desired thickness. In some embodiments, the present disclosure relates to a microtomy system, further including an actuator, in communication with the control system, configured to displace the tissue chuck along a vertical axis, wherein the control loop controls the actuator to displace the tissue chuck along the vertical axis such that the one or more tissue sections have a desired thickness. In some embodiments, the present disclosure relates to a microtomy system, further including: a first actuator, in communication with the control system, configured to displace the tissue chuck along the horizontal axis; and a second actuator, in communication with the control system, configured to displace the tissue chuck along a vertical axis, wherein the control loop controls the first actuator to displace the tissue chuck along the horizontal axis and the second actuator to displace the tissue chuck along the vertical axis such that the one or more tissue sections have a desired thickness. In some embodiments, the present disclosure relates to a microtomy system further including: a first actuator, in communication with the control system, configured to displace the tissue chuck along a vertical axis; and a second actuator, in communication with the control system, configured to displace the tissue chuck along the horizontal axis.

The present disclosure relates to a control system, including: at least one non-transitory computer-readable storage medium having encoded thereon executable instructions that, when executed by at least one processor, cause the at least one processor to carry out a method including: receiving information indicative of a relative axial location of a microtome blade to a tissue chuck along a horizontal axis, wherein: the microtome blade is configured to remove one or more tissue sections from a tissue block accepted in the tissue chuck; the microtome blade and the tissue chuck are axially displaceable relative to one another along the horizontal axis; and using a control loop to control the relative axial location of the microtome blade to the tissue chuck such that the one or more tissue sections have a desired thickness.

In some embodiments, the present disclosure relates to a control system, wherein the method further includes: receiving the relative axial location of the microtome blade to the tissue chuck from one or more position sensors configure to collect information indicative of the relative axial location; and controlling an actuator to displace the tissue chuck along the horizontal axis In some embodiments, the present disclosure relates to a control system, wherein the one or more position sensors are configured to measure an axial location of the tissue chuck and an axial location of the microtome blade along the horizontal axis. In some embodiments, the present disclosure relates to a control system, wherein the method further includes actuating an axial actuator coupled to the tissue chuck to displace the tissue chuck as a function of the relative axial location of the microtome blade to the tissue chuck. In some embodiments, the present disclosure relates to a control system, wherein the method further includes receiving information indicative of the relative axial location of the microtome blade to the tissue chuck from one or more force sensors, and controlling an actuator to displace the tissue chuck along the horizontal axis. In some embodiments, the present disclosure relates to a control system, wherein the information indicative of the relative axial location is a force applied to the tissue block from the microtome blade. In some embodiments, the present disclosure relates to a control system, wherein the method further includes controlling an actuator to displace the tissue chuck along the horizontal axis such that the one or more tissue sections have a desired thickness. In some embodiments, the present disclosure relates to a control system, wherein the method further includes controlling an actuator to displace the tissue chuck along a vertical axis such that the one or more tissue sections have a desired thickness. In some embodiments, the present disclosure relates to a control system, wherein the method further includes controlling a first actuator to displace the tissue chuck along the horizontal axis and a second actuator to displace the tissue chuck along a vertical axis such that the one or more tissue sections have a desired thickness.

The present disclosure relates to a microtomy system, including: one or more position sensors configured to collect information indicative of a relative axial location along a horizontal axis of a microtome blade to a tissue chuck, wherein: the microtome blade is configured to remove one or more tissue sections from a tissue block, the microtome blade being axially offset from the tissue chuck along the horizontal axis; and the microtome blade and the tissue chuck are axially displaceable relative to one another along the horizontal axis; and a control system configured to receive information indicative of a relative axial location of the microtome blade to the tissue chuck along the horizontal axis, and to use a control loop to control the relative axial location of the microtome blade to the tissue chuck such that the one or more tissue sections have a desired thickness.

In some embodiments, the present disclosure relates to a microtomy system, further including an actuator, in communication with the control system, configured to displace the tissue chuck along the horizontal axis. In some embodiments, the present disclosure relates to a microtomy system, wherein the one or more position sensors are configured to measure an axial location of the tissue chuck and an axial location of the microtome blade along the horizontal axis. In some embodiments, the present disclosure relates to a microtomy system further including: an axial actuator coupled the tissue chuck to axially displace the tissue chuck, wherein the control system is configured to actuate the axial actuator to displace the tissue chuck as a function of the relative axial location of the microtome blade to the tissue chuck. In some embodiments, the present disclosure relates to a microtomy system further including: a series of elastic actuators for clamping the microtome blade that has an anisotropic structure so that it can provide high clamping forces on the microtome blade and conform to an opposing clamping plate-blade system in another direction while dissipating energy to passively control vibrations of the microtome blade. In some embodiments, the present disclosure relates to a microtomy system further including: one or more force sensors configured to collect information indicative of the relative axial location of the microtome blade to the tissue chuck and to communicate the relative axial location to the control system; and an actuator, in communication with the control system, configured to displace the tissue chuck along the horizontal axis. In some embodiments, the present disclosure relates to a microtomy system further including one or more force sensors positioned on the tissue chuck and configured to determine a force applied to the tissue block from the microtome blade. In some embodiments, the present disclosure relates to a microtomy system, wherein the information indicative of the relative axial location is a force applied to the tissue block from the microtome blade. In some embodiments, the present disclosure relates to a microtomy system, further including an actuator, in communication with the control system, configured to displace the tissue chuck along a vertical axis. In some embodiments, the present disclosure relates to a microtomy system, wherein the actuator is coupled to a leadscrew via a non-rigid system configured to decouple the leadscrew from the actuator. In some embodiments, the present disclosure relates to a microtomy system, further including an actuator, in communication with the control system, configured to displace the tissue chuck along the horizontal axis, wherein the control loop controls the actuator to displace the tissue chuck along the horizontal axis such that the one or more tissue sections have a desired thickness. In some embodiments, the present disclosure relates to a microtomy system, further including an actuator, in communication with the control system, configured to displace the tissue chuck along a vertical axis, wherein the control loop controls the actuator to displace the tissue chuck along the vertical axis such that the one or more tissue sections have a desired thickness. In some embodiments, the present disclosure relates to a microtomy system, further including: a first actuator, in communication with the control system, configured to displace the tissue chuck along the horizontal axis; and a second actuator, in communication with the control system, configured to displace the tissue chuck along a vertical axis, wherein the control loop controls the first actuator to displace the tissue chuck along the horizontal axis and the second actuator to displace the tissue chuck along the vertical axis such that the one or more tissue sections have a desired thickness.

The present disclosure relates to a microtomy system for controlling tissue section thickness, the microtomy system including: a tissue chuck configured to accept a tissue block; a microtome blade configured to remove one or more tissue sections from the tissue block, the microtome blade being axially offset from the tissue chuck along a horizontal axis, wherein the microtome blade and the tissue chuck are axially displaceable relative to one another along the horizontal axis; one or more sensors configured to collect information indicative of a relative axial location along the horizontal axis of the microtome blade to the tissue chuck; an actuator configured to displace the tissue chuck along the horizontal axis; and a control system configured to receive information indicative of a relative axial location of the microtome blade to the tissue chuck along the horizontal axis, and to use a control loop to control the relative axial location of the microtome blade to the tissue chuck such that the one or more tissue sections have a desired thickness.

In some embodiments, the present disclosure relates to a microtomy system, wherein the one or more sensors are configured to measure an axial location along the horizontal axis of the tissue chuck and an axial location of the microtome blade along the horizontal axis. In some embodiments, the present disclosure relates to a microtomy system, wherein the actuator is an axial actuator coupled the tissue chuck to axially displace the tissue chuck, and wherein the control system is configured to actuate the axial actuator to displace the tissue chuck as a function of the relative axial location of the microtome blade to the tissue chuck. In some embodiments, the present disclosure relates to a microtomy system further including: a series of elastic actuators for clamping the microtome blade that has an anisotropic structure so that it can provide high clamping forces on the microtome blade and conform to an opposing clamping plate-blade system in another direction while dissipating energy to passively control vibrations of the microtome blade. In some embodiments, the present disclosure relates to a microtomy system further including: one or more force sensors configured to collect information indicative of the relative axial location of the microtome blade to the tissue chuck and to communicate the relative axial location to the control system. In some embodiments, the present disclosure relates to a microtomy system further including one or more force sensors positioned on the tissue chuck and configured to determine a force applied to the tissue block from the microtome blade. In some embodiments, the present disclosure relates to a microtomy system, wherein the information indicative of the relative axial position is a force applied to the tissue block from the microtome blade. In some embodiments, the present disclosure relates to a microtomy system, further including a second actuator, in communication with the control system, configured to displace the tissue chuck along a vertical axis. In some embodiments, the present disclosure relates to a microtomy system, wherein the second actuator is coupled to a leadscrew via a non-rigid system configured to decouple the leadscrew from the second actuator. In some embodiments, the present disclosure relates to a microtomy system, wherein the control loop controls the actuator to displace the tissue chuck along the horizontal axis such that the one or more tissue sections have a desired thickness. In some embodiments, the present disclosure relates to a microtomy system, further including a second actuator, in communication with the control system, configured to displace the tissue chuck along a vertical axis, wherein the control loop controls the second actuator to displace the tissue chuck along the vertical axis such that the one or more tissue sections have a desired thickness. In some embodiments, the present disclosure relates to a microtomy system, further including: a second actuator, in communication with the control system, configured to displace the tissue chuck along a vertical axis, wherein the control loop controls the actuator to displace the tissue chuck along the horizontal axis and the second actuator to displace the tissue chuck along the vertical axis such that the one or more tissue sections have a desired thickness.

These and other embodiments of the present disclosure are described in more detail below.

### BRIEF DESCRIPTION OF DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1A is an above view illustration of a sample system layout in accordance with some embodiments of the present disclosure;

FIGS. 1B and 1C are isometric view illustrations of a sample system layout in accordance with some embodiments of the present disclosure;

FIG. 2A is a side view illustration of a sample system layout in accordance with some embodiments of the present disclosure;

FIG. 2B is a top view illustration of a sample system layout in accordance with some embodiments of the present disclosure;

FIG. 2C is a side sectional view illustration of a sample system layout in accordance with some embodiments of the present disclosure;

FIG. 2D is a side view illustration of a sample system layout in accordance with some embodiments of the present disclosure;

FIG. 2E is a rear perspective view illustration of a sample system layout in accordance with some embodiments of the present disclosure;

FIG. 2F is a rear sectional view illustration of a sample system layout in accordance with some embodiments of the present disclosure;

FIG. 2G is a perspective view of a sample system layout in accordance with some embodiments of the present disclosure;

FIG. 2H presents a side view of a clamp plate that can be used to hold a microtome blade in place;

FIG. 2I presents a front view of the clamp plate of FIG. 2H;

FIG. 3 is a flow chart illustration of a sample method of operation in accordance with some embodiments of the present disclosure;

FIG. 4 is a flow chart illustration of a sample method of operation in accordance with some embodiments of the present disclosure;

FIG. 5 is a flow chart illustration of a sample method of operation in accordance with some embodiments of the present disclosure; and

FIG. 6 is an exemplary high-level architecture for implementing processes in accordance with the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure relates to systems and methods for processing tissue blocks containing biological samples of tissue. The processing can include automated systems designed to face tissue blocks and cut tissue sections from the tissue block. The cut tissue sections can be transferred to a transfer/transport medium such as tape and then, from the transfer medium to slides for pathology or histology examination. The presently disclosed methods and systems may be employed in connection with manual as well as automated microtomy methods and systems.

In some embodiments, the present disclosure provides systems and methods that ensure that the set thickness of the tissue sections is consistently achieved. In general, the output of a microtomy is a section of tissue that is on a slide. The section of tissue can then be stained and analyzed by a pathologist under a microscope. However, if the thickness of the section of tissue is not uniform, from sample to sample (i.e., from slide to slide each with a different tissue section), the pathologist will have to refocus the microscope for each sample as they analyze it. Having to refocus the microscope for hundreds of slides can add a significant amount of time to the process of analyzing the tissue. Alternatively, if stained slides are digitized, the whole slide scanner will need to auto-focus on different regions of the slides, which again adds time and costs to the process. Thus, the systems and methods of the present disclosure are designed to ensure uniform thickness of tissue sections, thus decreasing the time needed to process hundreds of slides by pathologists.

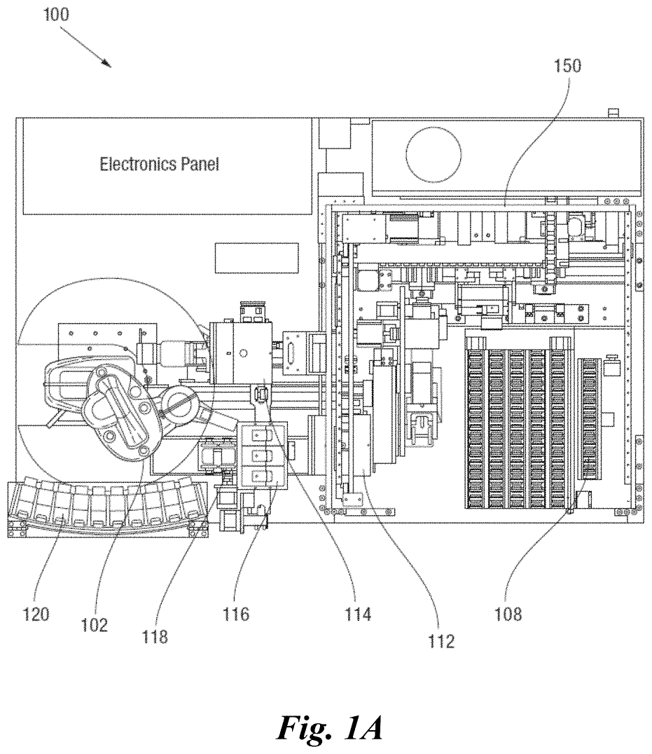

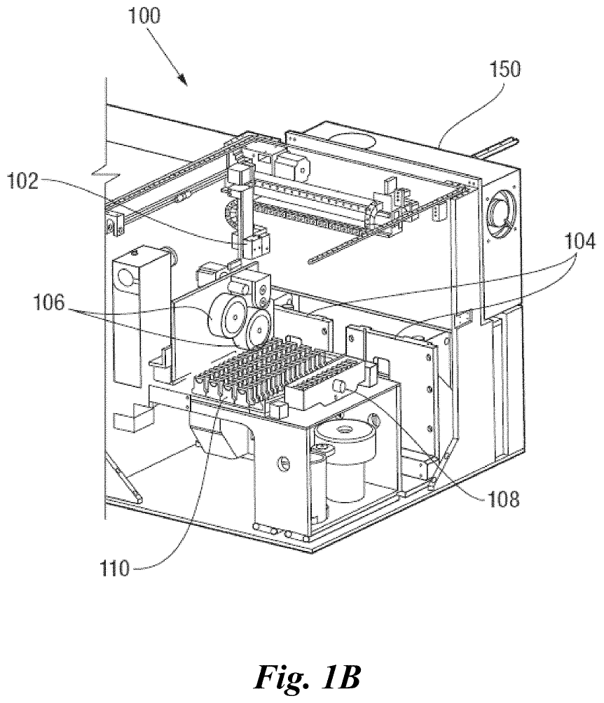

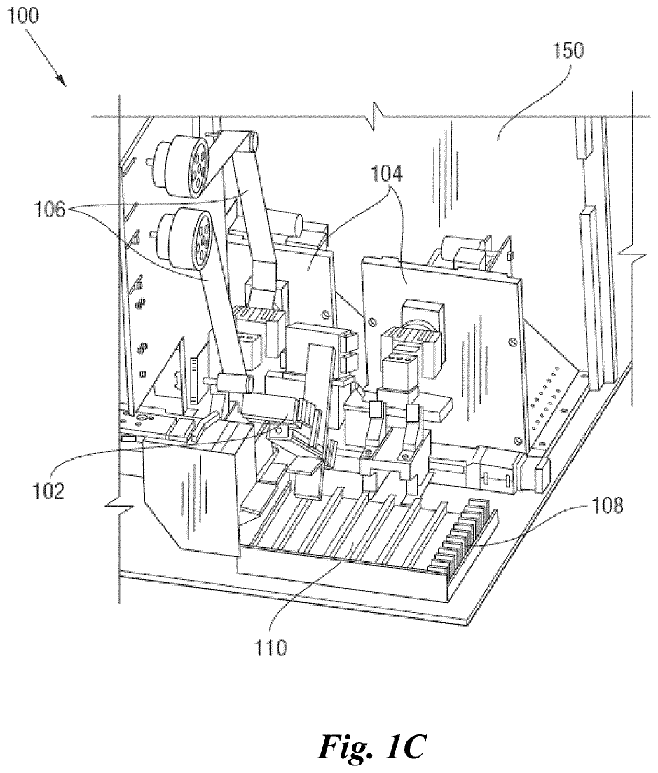

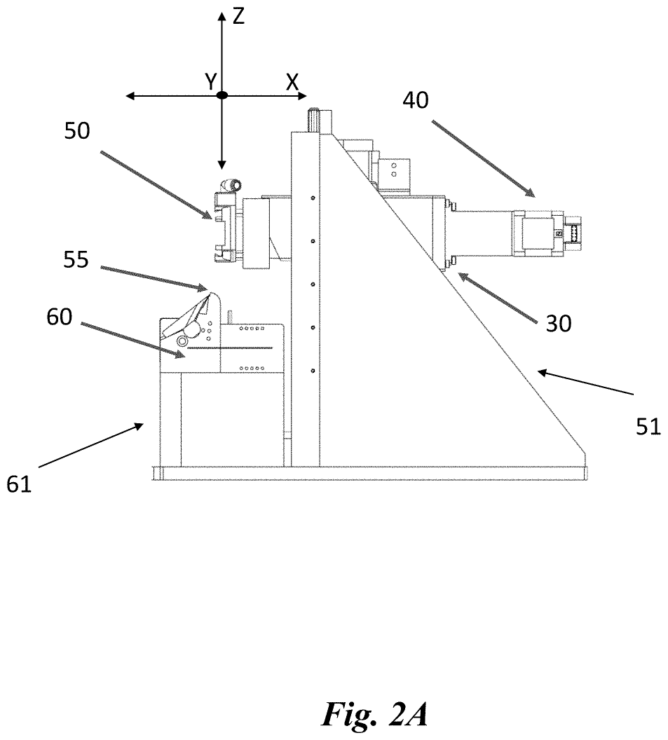

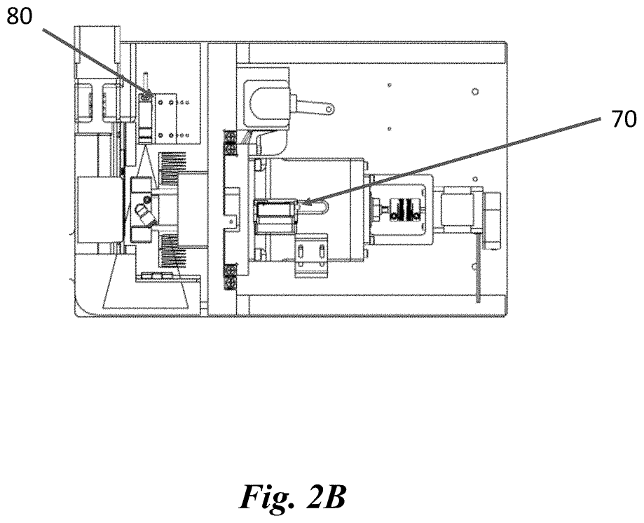

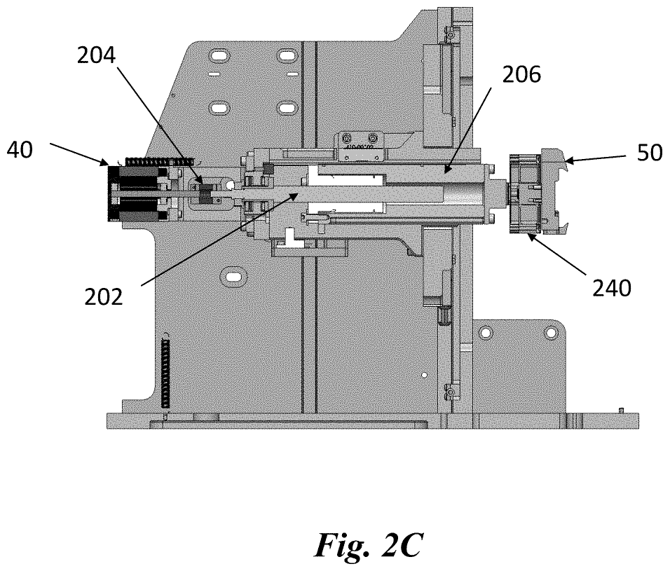

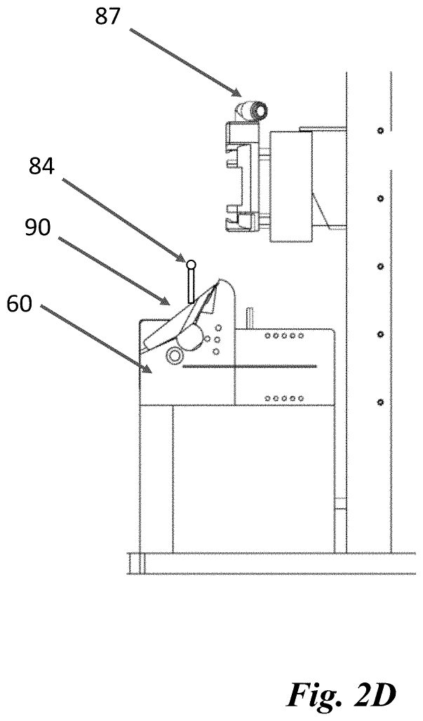

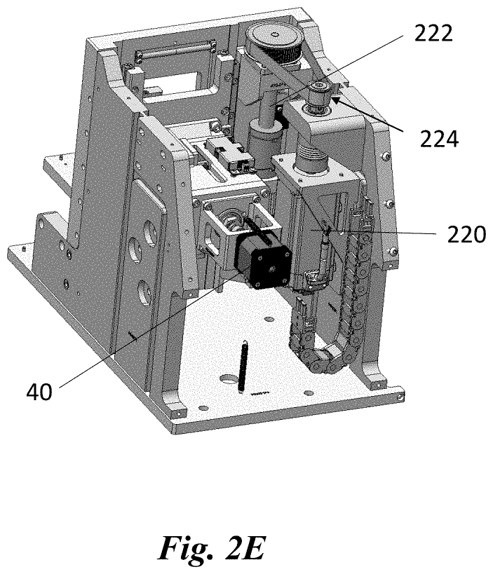

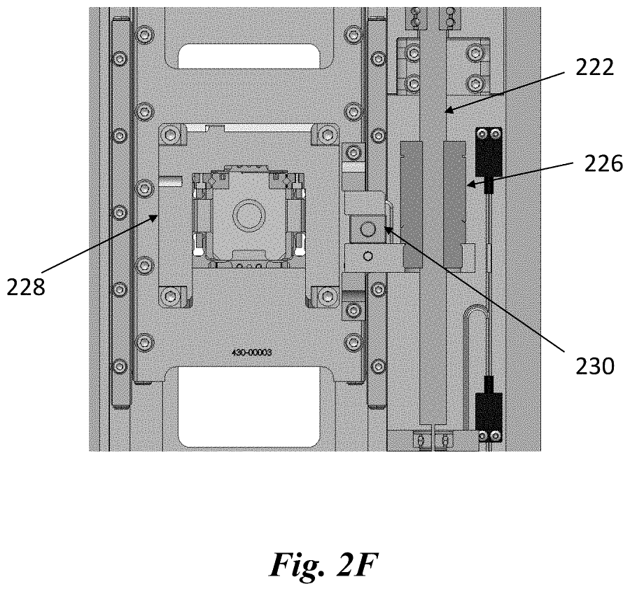

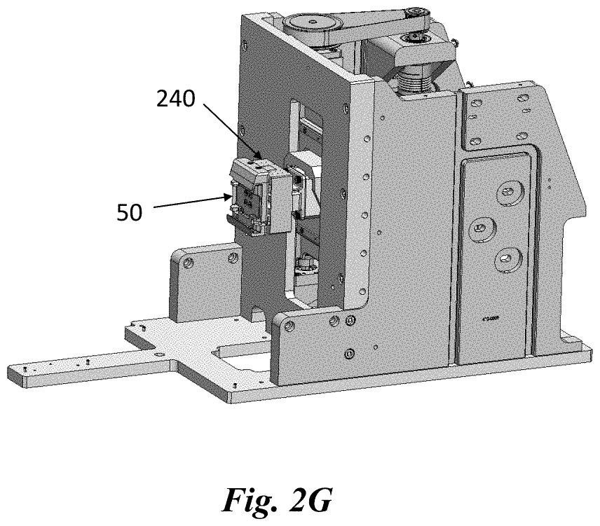

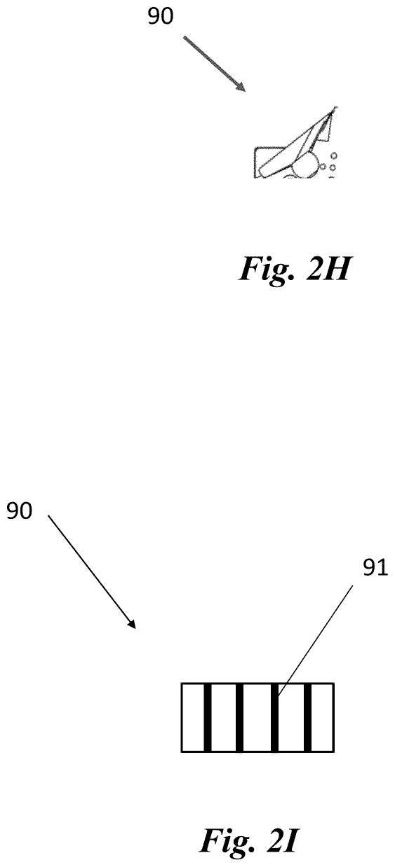

FIG. 1A is an above view illustration of a sample system layout in accordance with some embodiments of the present disclosure. FIGS. 1B and 1C are isometric view illustrations of a sample system layout in accordance with some embodiments of the present disclosure. FIG. 2A is a side view illustration of a sample system layout in accordance with some embodiments of the present disclosure. FIG. 2B is a top view illustration of a sample system layout in accordance with some embodiments of the present disclosure. FIG. 2C is a side sectional view illustration of a sample system layout in accordance with some embodiments of the present disclosure. FIG. 2D is a side view illustration of a sample system layout in accordance with some embodiments of the present disclosure. FIG. 2E is a rear perspective view illustration of a sample system layout in accordance with some embodiments of the present disclosure. FIG. 2F is a rear sectional view illustration of a sample system layout in accordance with some embodiments of the present disclosure. FIG. 2G is a perspective view of a sample system layout in accordance with some embodiments of the present disclosure. FIG. 2H presents a side view of a clamp plate that can be used to hold a microtome blade in place. FIG. 2I presents a front view of the clamp plate of FIG. 2G.

In some embodiments, the present disclosure can be used with tissue blocks containing biological samples, such as tissue. The system and method of the present disclosure can be used for efficiently processing and separating the tissue blocks. The tissue samples are typically embedded in a preservation material, such as paraffin wax or a similar material. The embedding process can include any combination of processes for producing tissue blocks which are designed to be cut by microtomes 104. For example, biological samples can be encased within a mold along with a liquid substance, such as wax or epoxy, that can harden to produce the desired shaped block. Once tissue blocks have been created, they can be inserted into an automated system 100 for cutting into tissue sections that can be placed on slides for observation.

In particular, as is discussed in more detail below, the automated system 100 is designed to accept one or more tissue blocks, where each tissue block comprises a tissue sample embedded in an embedding or preservation material. The tissue blocks are delivered to one or more microtomes 104. Next, the one or more tissue blocks are “faced” using one or more microtomes 104 by removing the layer of the preservation material in which the tissue sample is embedded to expose a large cross section of the tissue sample, for example, the front face of the tissue sample. Such exposed surface of the tissue sample of the tissue block is referred to as a blockface. Once the tissue block is faced, the tissue block can be hydrated and cooled prior to sectioning (cutting tissue sections that can be placed on slides for observation) the tissue block. Next, one or more tissue sections comprising a portion of the tissue sample can be sliced from the faced tissue block using one or more microtomes 104. The tissue sections are transferred, for example, using automated transfer medium, from the one or more microtomes 104 to slides for further processing.

Referring to FIGS. 1A, 1B, and 1C, in some embodiments, an automated pathology system 100 is provided for preparing slides of tissue sections. Such systems can be configured for increased throughput during tissue sectioning. The system 100 can be designed to include a block handler 102, one or more microtomes 104, a transfer medium 106 (e.g., a tape), a hydration chamber 108, and a block tray 110. The block tray 110 can be a drawer-like device designed to hold a plurality of tissue blocks and can be placed into the system 100 for access by the block handler 102. The block tray 110 can have multiple rows each designed to hold one or more tissue blocks and can have sufficient spacing such that the block handler 102 can index, grab, and remove one tissue block at a time. In some embodiments, the block tray 110 can be designed to securely hold the tissue blocks by using, for example, a spring-loaded mechanism, so that the tissue blocks do not shift or fall out of the block tray 110 during handling. In some embodiments, the spring-loaded mechanism can further be designed such that the block handler 102 can pull the tissue blocks out without damaging or deforming them. For example, the pitch of the tissue blocks within the block tray 110 can enable the block handler grippers of the block handler 102 to access a paraffin block without interfering with adjacent blocks. The block handler 102 can include any combination of mechanisms capable of grasping and/or moving tissue blocks in and out of a microtome 104, specifically, into a chuck 50 (FIG. 2A) of the microtome 104. For example, the block handler 102 can include a gantry, a push and pull actuator, or a gripper on a Selective Compliance Assembly Robot Arm (SCARA) robot.

Still referring to FIGS. 1A, 1B, and 1C, in some embodiments, the system 100 can include a combination of mechanisms to transfer a tissue section cut from the tissue block onto the transfer medium 106 to be transferred to a slide for analysis. The combination of mechanisms can include a slide adhesive coater 112, a slide printer 114, slide input racks 116, a slide singulator that picks a slide from a stack of slides 118, and slide output racks 120. This combination of mechanisms can work together to prepare the tissue section on the slide and prepare the slide itself.

In some embodiments, the one or more microtomes 104 can include any combination of microtomes known in the art, specifically, for precisely sectioning tissue blocks. For example, the one or more microtomes 104 can be a rotary, cryomicrotome, ultramicrotome, vibrating, saw, laser, etc. based design.

In some embodiments, the one or more microtomes 104, as shown in FIG. 2A, can include a chuck assembly 51 and a cutting assembly 61. In some embodiments, the chuck assembly 51 and the cutting assembly 61 (FIG. 2A) can move relative to each other up and down along a vertical axis (i.e. in the Z direction shown in FIG. 2A), axially along a horizontal axis (e.g., in a direction of the thickness of a tissue block, the X direction shown in FIG. 2A), and/or laterally or rotationally (i.e. in the Y direction shown in FIG. 2A). In some embodiments, the chuck assembly 51 can move in three directions relative the cutting assembly 61. The one or more microtomes 104 can include any combination of components for receiving and sectioning a tissue block. For example, the one or more microtomes 104 can include a knife-block with a blade handler for holding a changeable knife blade and a specimen holding unit with a chuck head and a chuck adapter for holding a tissue block.

In some embodiments, the one or more microtomes 104 is configured to cut a tissue section from a tissue sample enclosed in a supporting block of preservation material such as paraffin wax. The one or more microtomes 104 can hold a blade 55 (FIG. 2A) aligned for cutting tissue sections from one face of the tissue block—the block cutting face or blockface. For example, a rotary microtome, can linearly oscillate the chuck 50 holding the tissue block with the block cutting face in the blade-cutting plane, which combined with incremental advancement of the block cutting face into the cutting plane, the microtome 104 can successively shave thin tissue sections off the block cutting face. While the blade 55 is particularly discussed in detail herein, it should be appreciated that the same description can apply to any other cutting mechanisms that may be included in the microtome.

In operation, the one or more microtomes 104 is used to face and/or section tissue blocks. When the tissue block is initially delivered to the one or more microtomes 104, the tissue block can be faced. Facing is removing a layer of preservation material from the tissue block and exposing the large cross section of the tissue sample embedded in the tissue block. That is, the preservation material, with the tissue sample embedded in it, can first be subjected to sectioning with relatively thick sections to remove the 0.1 mm-1 mm layer of paraffin wax on top of the tissue sample. When enough paraffin has been removed, and the complete outline of the tissue sample is exposed, the block is “faced” and ready for acquisition of a processable tissue section that can be put on a glass slide. The exposed face may be referred to as a blockface or block cutting face. For the facing process, the one or more microtomes 104 can shave off sections of the tissue block until an acceptable portion of the tissue sample within the tissue block is revealed. In some embodiments, the system can include on or more facing cameras to identify when an acceptable portion of the tissue sample within the tissue block is revealed. For the cutting process, the one or more microtomes 104 can shave off a section of the tissue sample of the tissue block with an acceptable thickness to be placed on a slide for analysis.

Once the tissue block is faced, in some embodiments, the faced tissue block can be hydrated (for example, in a hydration chamber 108 or directly at the one or more microtomes 104) for a period of time in a hydrating fluid. In addition to being hydrated, the tissue block can be cooled. The cooling system can be part of the hydration chamber 108 or a separate component from the hydration chamber 108. In some embodiments, the cooling system can provide cooling to all the components within a sectioning chamber 150. The sectioning chamber 150 can provide insulation enclosing the one or more microtomes 104, the hydration chamber 108, the block tray 110, the blade holder and the blade exchanger of the microtome 104, and the cameras. This way there are minimal number of openings in the insulation, which can increase the efficiency and effectiveness within the sectioning chamber 150. Regardless of location, the cooling system can have a mini compressor, a heat exchanger, and an evaporator plate to create a cool surface. The air in the sectioning chamber 150 can be pulled in and passed over the evaporator plate, for example, using fans. The cooled air can circulate in the sectioning chamber 150 and/or hydration chamber 108 to cool the paraffin tissue blocks. The mass of equipment in the cooling chamber provides a thermal inertia as well. Once the chamber is cooled, its temperature can be maintained more effectively, for example, if an access door is opened by the user to remove the block tray 110. In some embodiments, the temperature of the tissue block is maintained between 4° C. to 20° C. Keeping the tissue blocks cool can benefit the sectioning process as well as the hydration process.

Once the tissue block has been sufficiently hydrated, in some embodiments, it is ready for sectioning. Essentially, the one or more microtomes 104 cuts thin sections of the tissue samples from the tissue block. The tissue sections can then be picked up by the transfer medium 106, such as a tape, for subsequent transfer for placement on the slides. In some embodiments, depending on the microtome 104 setup of the system 100, the system 100 can include a single or multiple transfer medium 106 units. For example, in tandem operation, the transfer medium 106 can be associated with a polishing and sectioning microtome 104, whereas in a parallel operation, a separate transfer medium 106 can be associated with each microtome 104 within the system 100. In some automated systems, each of these processes/steps of facing, hydration, sectioning, and transfer to slides are computer controlled rather than performed in the manual workflow by the histotechnician.

Still referring to FIGS. 1A, 1B, and 1C, in some embodiments, the transfer medium 106 can be designed in a manner in which a tissue section cut from the tissue sample in the tissue block adheres to and can then be transported by the moving transfer medium 106. For example, the transfer medium 106 can include any combination of materials designed to physically (e.g., electrostatically) and/or chemically adhere to the tissue sample material (e.g., a tissue section). The transfer medium 106 can be designed to accommodate a large number of tissue sections to be transferred to slides for evaluation. In some embodiments, the transfer medium 106 can be replaced by a water channel to carry tissue. The system 100 can include any additional combination of features for use in an automated microtome design.

In some embodiments, the system 100 can follow a process to face, hydrate, section, and transport cut tissue sections to slides in an efficient automated fashion.

Referring now to FIGS. 1A-2I, in some embodiments, the chuck 50 of the one or more microtomes 104 can rotate around a vertical and/or a horizontal axis to align the blockface with a vertical plane defined by the microtome blade 55 (i.e. the cutting plane). In some embodiments, a laser sensor, ultrasonic sensor or another type of sensor can be used to determine the angle of the blockface relative to a vertical plane such that a rotation around a vertical axis and/or a horizontal axis can align the blockface plane to the microtome blade 55 plane. Such a feature can reduce the number of cuts to get to the tissue (i.e. face the tissue block) and decreases the risk of chunking the tissue sample out of the paraffin block (chunking a tissue sample means dislodging a tissue sample out of the tissue block due to the force the blade exerts on the tissue sample while cutting). In some embodiments, the tissue block can be oriented such that a larger cross section of the embedded tissue sample is parallel to the cutting plane. In some embodiments, due to poor tissue embedding in paraffin block, the tissue sample cross-section can deviate from this ideal configuration. A rotation around the vertical and/or horizontal axes could help achieve alignment of the blockface with the cutting plane.

In some embodiments, the system 100 can include an active control in the thickness axis (i.e. the direction X in FIG. 2A) to ensure consistent cut thickness of the tissue. The thickness axis may generally be understood as the direction in which a thickness of a tissue section is measured. In some embodiments, the active control can be run in an open loop. In some embodiments, the active control can include a passive control system which can be an open-loop system. In an open-loop system, outputs of the system may not be used to generate a control signal based on a desired set point. The open-loop system can, once put in motion, keep itself in the same status as it started as much as possible. For example, via the use of passive components, such as springs and dampers, the system can maintain a relative location of the tissue chuck 50, with respect to the underlying system. In some embodiments, with an open-loop system there is no need for a mechanism to ensure that the relative location of a component, such as the tissue chuck 50, is maintained. In general, an open-loop system can have large inertia and/or passive mechanisms such as springs and other restorative elements to bring the system back to the predefined, intended, operational configuration (i.e., to return the chuck 50 to a desired position). In a passive system the inertia, or passive, mechanism can be added at any location between a motor and the tissue chuck 50. In some embodiments, the inertia, or passive, mechanism can be disposed closer to the tissue chuck 50. For example, a restorative spring can be placed on the same motion axis as the tissue chuck 50 to store energy when the tissue block is disturbed by external forces. An open-loop system can use sensors to detect when it cannot deliver the system to an operational range.

In some embodiments, the location of the chuck 50, with respect to the system generally or with respect to the blade 55 of the microtome 104, can be controlled with an actuator 40 to adjust the thickness of a tissue section cut with the blade 55. In some embodiments, the actuator 40 may be a stepper or a brushless DC rotary motor which can axially actuate the chuck 50 with respect to the device to move the chuck in the direction X. The direction X can be described herein as the axial direction along the horizontal axis or horizontal direction. The axial direction along the horizontal axis is generally perpendicular to the cutting plane. Movement of the chuck 50 in the axial direction along the horizontal axis can move the chuck 50 and tissue block received in the chuck 50 toward or away from the blade 55 or the vertical cutting plane defined by the blade 55. Actuation of the actuator 40 can axially drive the sample chuck 50, towards or away from the sectioning blade 55 of the microtome 104 in the direction X. The location of the blade 55 can be defined as being axially offset or spaced apart (e.g., in the direction X) from the relative location of the chuck 50. The distance, in the direction X, between the chuck 50 and the blade 55 can be a variable distance that can account for the thickness of a tissue section cut from the tissue block. In use, the chuck 50 holds a tissue block for sample preparation. In some embodiments, rotational motion of a rotary motor actuator can be converted to linear motion using a transmission device including a ball-bearing or a leadscrew. In some embodiments, the load of the thickness axis can be carried by cross roller-bearings 30. The cross roller-bearings 30 can aid in a reduction of parasitic phenomena such as stick-slip and underlying friction. The cross roller-bearings 30 can be mounted horizontally along the stroke of the microtome 104 in the tissue thickness direction X. Ensuring that the actuator 40 provides for a smooth and accurate translation of the sample chuck 50 can result in consistent cut thickness of tissue sections of a tissue sample of a tissue block.

In some embodiments, the actuator 40 can be a linear brushless DC motor that eliminates the need to convert rotational motion to linear motion. In some embodiments, the actuator 40 can be a piezo-electric stage. A piezo-electric stage can be very stiff and impart very precise motion. In some embodiments, it is possible to have a piezo-electric motion stage that does not require any linear bearings to carry the load and avoid stick-slip forces.

In some embodiments, the actuator 40 can impart motion to the chuck 50 through an axial drive mechanism coupled to the chuck 50. For instance, in some embodiments, the actuator 40 can be coupled to an axial leadscrew 202 via a motor coupler 204. In some embodiments, the coupler 204 can be a decoupler or made of force or motion absorbent material such that vibrations from the actuator 40 are not transmitted to the leadscrew 202. In some embodiments, the leadscrew 202 can be coupled to a shaft 206 such that rotational motion of the leadscrew 202 imparts linear motion of the shaft 206 in the axial direction. In some embodiments, the chuck 50 can be coupled to the shaft 206 such that the shaft 206 moves the chuck 50 in the axial direction.

In some embodiments, the location of the chuck 50, with respect to the system generally or with respect to the blade 55 of the microtome 104, can be controlled with an actuator 220 to adjust the position of the chuck 50 along the vertical axis or in the direction Z. The Z direction is generally orthogonal to the X direction (i.e. the axial direction) and parallel to the cutting plane. The Z direction may be referred to as the slicing direction or slicing axis. The Z direction may be referred to as the vertical direction or direction along the vertical axis. In some embodiments, movement of the chuck 50 in the Z direction relative the blade 55 may result in a cutting or slicing of a tissue block received in the chuck 50 by the blade 55. In some embodiments, movement of the chuck 50 in the Z direction, and particularly movement of the chuck 50 such that a tissue block retained in the chuck 50 is moved in the cutting plane defined by the blade 55 in the Z direction, can slice a tissue section from a tissue block. In some embodiments, the actuator 220 can be a stepper, a brush motor, a brushless DC rotary motor, or any other suitable motor. In some embodiments, the actuator 220 can mounted to the system via a compliant vibration dampener comprised of rubber, silicone, plastic or other soft materials. In some embodiments, the actuator 220 can be coupled to a lead screw 222 via a non-rigid system 224. In some embodiments, the non-rigid system 224 can be a belt drive or chain drive. The non-rigid system 224 can allow the actuator 220 to decouple from the lead screw 222. By decoupling the actuator 220 from the lead screw 222, motor vibrations from the actuator 220 may not be transferred to the leadscrew 222 and the vertical drive mechanism. Eliminating the transmission of such vibrations may reduce or eliminate ripples from forming in a tissue section cut from a tissue block. A leadscrew nut 226, which translates rotational motion of the leadscrew 222 to linear motion in the direction Z can be coupled to one or more components of the axial drive mechanism or axial assembly to move one or more components of the axial drive mechanism or assembly, and the chuck 50, in the Z direction. For instance, in some embodiments, the leadscrew nut 226 can be coupled to an X-axis assembly arm 228 to translate the assembly arm 228 and the chuck 50 in the direction Z. In some embodiments, the leadscrew nut 226 can be coupled to the X-axis assembly arms 228, or one or more other components of the axial drive mechanism or axial assembly via a single-directional constraint mechanism 230. The single-directional constraint mechanism 230 intentionally allows micro-motion in all other axes except the Z direction such that the coupling of undesirable motion from other axes (i.e. the X and/or Y axes) into the travel axis (i.e. Z axis) of the vertical drive mechanism. While vertical motion of the chuck 50 is described above as being driven by a leadscrew, it should be appreciated that the vertical motion of the chuck 50 may be provided by any type of screw driven system with or without ant-backlash features.

Precise and accurate control of the speed of movement of the chuck 50 in the Z direction and/or the vertical motion profile of the chuck 50 in the Z direction when sectioning a tissue block can better control the quality of tissue sections cut from tissue blocks. For instance, artifacts such as ripples, chatter, chunking, tears in the tissue section, or wrinkles in the tissue section can be reduced or eliminated. Precise and accurate control of the speed of movement of the chuck 50 in the Z direction and/or the vertical motion profile of the chuck 50 in the Z direction when sectioning a tissue block can improve tissue section thickness control. For instance, after a particular section thickness is “set” by selectively positioning the chuck 50 in the X direction relative the blade 55, the actual thickness of the tissue section cut from a tissue block may vary from the “set” thickness due to the speed of movement and/or motion profile of the chuck in the Z direction during a cutting stroke.

In addition to the improved resolution of movement by the actuator assemblies, the system 100 can include a sensor for determining the thickness axis (e.g., in the direction X) motion position, of the chuck 50 for instance. The thickness axis motion position can be sensed by a sensor, or non-contact linear encoder, 70 attached to the chuck 50 holding the tissue block, or a laser sensor 80 that is pointing to the chuck 50 holding the tissue block or pointing to the tissue block itself. Non-contact linear encoders can be one, or a combination, of optical sensors, laser sensors, magnetic sensors, or other non-contact sensor types. In some embodiments the laser sensor 80 can measure the gap between the tissue block (i.e. the blockface), or chuck 50, and the blade 55 or a fixed reference on a blade holder 60. In some embodiments, the laser 80 can be referenced to a fixed point on the blade holder, or microtome base 60. In some embodiments, multiple sensors can be used to detect the location of the tissue block more accurately. It should be appreciated that the non-contact linear encoder 70 and laser sensor 80 are merely examples of position sensors that can measure the relative position of the chuck 50 and the blade 55, and that any other suitable position sensors are contemplated herein.

In some embodiments, one or more force sensors 240 can be mounted on or in the system 100 such that the cutting forces during sectioning can be measured. In some embodiments, the one or more force sensors are coupled to a rear side of the chuck 50 and/or an end of the shaft 206 such that the one or more force sensors 240 are positioned between the chuck 50 and the shaft 206. In some embodiments, the one or more force sensors 240 may be embedded in the chuck 50 and/or embedded in the shaft 206. The one or more force sensors 240 may be configured to measure forces in one or more directions or axes of motion (i.e. any or all of the X direction, Y direction, or Z direction). The one or more force sensors 240 can determine the force imparted on the tissue block during movement of the chuck 50 during sectioning. In some embodiments, the magnitude of the force measurement during the motion of the chuck 50 can inform the system of one or more physical phenomena, including detection of an actual cut of a tissue block, detection of irregular or chattering cuts, detection of inconsistent thickness of cut, and/or detection of tissue sample conditions. In some embodiments, the time-series data from the one or more force sensors 240 can be used to calculate the length of cut (the distance of a cutting stroke through the tissue block or the duration of time to complete a cutting stroke through the tissue block), the maximum cutting force during a single cutting stroke and/or multiple cutting strokes of the same tissue block, the average cutting force during a cutting stroke and/or multiple cutting strokes of the same tissue block, and/or the and minimum cutting force during a cutting stroke and/or multiple cutting strokes of the same tissue block. In some embodiments, the frequency-domain data from the one or more force sensors 240 can be used to detect tissue conditions and/or irregularities during cutting. In some embodiments, the data from the one or more force sensors 240 can be used to adjust the cutting speed and/or thickness setting of a cut of a tissue block. In some embodiments, the data from the one or more force sensors 240 can be used to profile vertical and/or horizontal motion during a cut. In some embodiments, the system 100 may include one or more torque sensors, which may be positioned similarly to any of the above force sensors 240. The one or more torque sensors may be configured to measure torque in one or more directions or about one or more axes of motion (i.e. any or all of the X direction, Y direction, or Z direction). Data from the torque sensors may be used alone or in combination with force data to make the determinations discussed above. It should be noted that other sensors (in addition or instead of the position sensor or force sensor) may be used to determine the relative position of the components of the microtome.

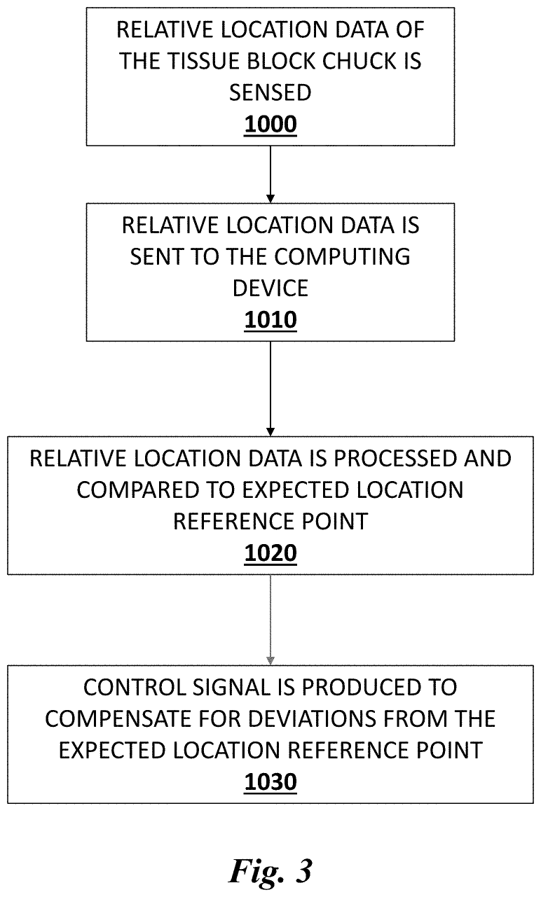

In some embodiments, the system 100 can implement a closed-loop control algorithm to receive sensor data and output control signals for the actuator 40 to drive the overall tissue block positioning system to decrease the error between a desired position and the actual position of the tissue block or chuck 50 detected by the sensors 70, 80. For example, as shown in FIG. 3, which depicts a flow chart illustration of a sample method of operation, in a first step 1000 the sensors 70, 80 can measure or determine the actual position, or relative location data, of the chuck 50 (or tissue block held by the chuck 50) relative to a fixed reference point. The sensors 70, 80 can, in a second step 1010, send the relative location data to a computing device. In a third step 1020 the computing device can process the relative location data with a control algorithm. If the control algorithm determines that the chuck 50 (or tissue block held by the chuck 50) is not in an expected location, or an expected location reference point, the computing device can, in a fourth step 1040, send an output control signal to the actuator 40 controlling the linear location of the chuck 50 to correct the axial location of the chuck 50 (or the tissue block) in the direction X to maintain tissue section thickness consistency. In some embodiments, the tissue section thickness can be a predefined value and the control algorithm can account for any relative movement between the tissue chuck 50 (or tissue block held by the chuck 50) and the blade 55 by linearly adjusting the location of the tissue chuck 50 with the actuator 40. In this way, the actuator 40 can be actuated using a preset control configuration, with the control system, before a respective cut is made to ensure that the tissue section thickness will be consistent through operation. The preset control configuration can be a function of the relative displacement in the X direction of the tissue chuck 50 (or tissue block held by the chuck 50) relative to the blade 55. Alternatively, or additionally, the fourth step can include alerting a user of the device for manual adjustment of the chuck 50 or the blade 55. The data and control signals can be in communication via a wired, or wireless, connection between the sensors 70, 80, the computing device, and the actuator 40.

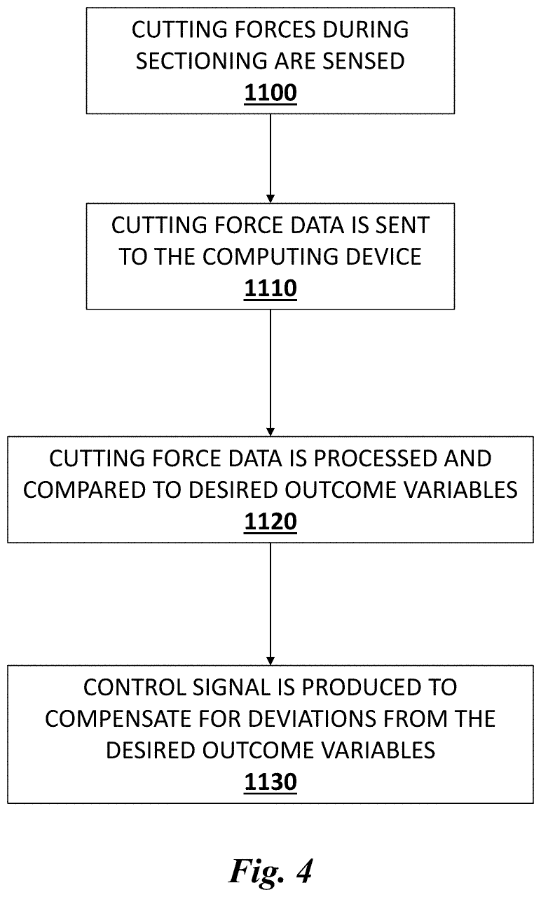

In some embodiments, the system 100 can implement a closed-loop control algorithm to receive the sensor data and output control signals for the actuator 40 and/or the actuator 220 to drive the overall tissue block positioning system to decrease the error between a desired tissue section thickness and an actual or future tissue section thickness determined from data from the one or more force sensors 240. For example, as shown in FIG. 4, which depicts a flow chart illustration of a sample method of operation in a first step 1100 the sensors 240 can measure or determine the cutting forces imparted on a tissue block during sectioning. The sensors 240 can, in a second step 1110, send the relative location data to a computing device. In a third step 1120 the computing device can process the cutting force data with a control algorithm. The cutting force data may include any or all of the data types described above when discussing the one or more force sensors 240, such as, but not limited to, magnitude of force, time-series force data, maximum force data, minimum force data, average force data, and/or frequency-domain force data. The computing device can compare the force data to one or more desired outcome variables, which include desired values for any or all of the above-listed data types. If the control algorithm determines that the force data does not meet a desired force data, the computing device can, in a fourth step 1140, send an output control signal to the actuator 40 controlling the linear location of the chuck 50 and/or a control signal to the actuator 220 controlling the vertical motion of the chuck 50 to adjust or correct the forces imparted on the tissue block during sectioning. As mentioned, any or all of the axial position of the chuck 50 relative the blade 55, speed vertical movement of the chuck 50 during sectioning, and vertical motion profile of the chuck 50 during sectioning, can influence both the forces imparted on the tissue block and the ultimate thickness of a tissue section cut from the tissue block. Therefore, by adjusting one or more of these control parameters, the computing device can achieve a desired force data point during sectioning and tissue section thickness. The desired cutting force data points can be pre-set, learned, or adjusted based on particular tissue block characteristics. The force-sensor measurements can be used for real-time feedback control loop or setting adjustment-based feed-back control. For real time feedback control, the control parameters can be adjusted real time during the cut if high force is sensed during the cut, for instance. In some embodiments, the control parameters can be adjusted for subsequent or future cuts based on the measurements taken during an initial or previous cut. In this way, the actuators 40 and 220 can be actuated, or a set to be actuated, using a preset control configuration, with the control system, before a respective cut is made to ensure that the tissue section thickness will be consistent and desired through operation. Alternatively, or additionally, the fourth step 1130 can include alerting a user of the device for manual adjustment of the chuck 50, the blade 55, or one or more programs or control settings of the actuators 40, 220. The data and control signals can be in communication via a wired, or wireless, connection between the sensors 70, 80, 240, the computing device, and the actuators 40, 220.

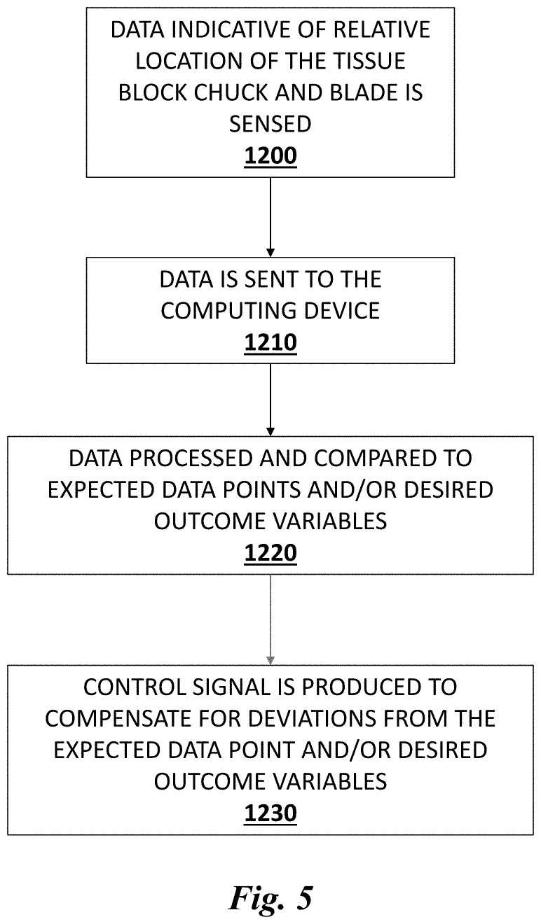

In some embodiments, the system can 100 can implement a closed-loop control algorithm to implement the methods of FIG. 3 and FIG. 4 concurrently or together. For instance, referring to FIG. 5, at a first step 1200, the sensors 70, 80, 240 can measure data indicative of the relative position of the blade 55 and chuck 50. The data indicative of the relative position may be the relative position data collected by the sensors 70, 80, and/or the force data collected by the one or more force sensors 240, as discussed above. At a second step 1210, the data indicative of the relative position of the blade 55 and chuck 50 can be sent to a computing device. In a third step 1220 the computing device can process the data with a control algorithm. In other words, the computing device can complete the processing steps discussed in both step 1020 of FIG. 3 and step 1120 of FIG. 4. If the control algorithm determines that the data does not meet an expected data point or desired outcome variable, the computing device can, in a fourth step 1240, send an output control signal to the actuator 40 controlling the linear location of the chuck 50 and/or a control signal to the actuator 220 controlling the vertical motion (speed and motion profile) of the chuck 50 to compensate for the deviations. That is, the computing device can send any or all of the control signals discussed in step 1030 of FIG. 3 and/or step 1130 of FIG. 4 to compensate for the deviations, as discussed in FIG. 3 and FIG. 4.

In some embodiments, the system can verify the thickness of a first tissue section cut from a tissue block, through one or more optical components for instance, and the computing device can send the control signals in step 1230, for instance, for a next or subsequent tissue section based on the thickness determination alone or in combination with the any or all of the data discussed above.

In some embodiments, an implementation of the methods shown in FIGS. 3, 4, and 5 can include a PID controller or a pre-filtered PID controller. In some embodiments an H∞ controller can be used to minimize the impact of the external disturbances such as stick-slip or friction force. An advantage of using PID or fixed structure controllers is that one can experimentally adjust control parameters without the need for a high-fidelity dynamic system model to design the control law. A factor that can increase the effectiveness of the control law may guarantee approaching the desired position from one side and keep the velocity non-zero until the target band is reached. A PID controller, in general, drives the error between a set point and the actual reading of the corresponding physical sensor readings. The PID controller can then work on the error itself, its derivative, and its integral over time. These operations can allow the PID controller to respond to the instantaneous changes in error (the derivative term), long term error accumulation (the integral term), and the error itself to provide increased granularity to the data for an increase in positional accuracy of the chuck 50.

Referring again to FIGS. 1A-2H, the instant system additionally provides for positional accuracy even after a tissue section is applied to the transfer system 106, such as a tape. Traditionally, when the tissue section is picked up by a tape system, after the tissue section has been cut from a tissue block, the positional accuracy of the system can be compromised. For example, when the tape is applied to the tissue block to collect to a tissue section just sliced from the tissue block, for instance, the force of the tape being applied can act on the chuck 50, in the X direction, and the chuck 50 can move, relatively to the right in FIG. 2A. In some cases, where the tape is a pressure sensitive adhesive (PSA) tape, the PSA tape often needs to be pushed firmly against the tissue section for it to adhere, thereby causing more pronounced displacement of the chuck 50. Regardless of the type of tape being used, it is desirable for the location of the tissue block to be maintained at less than a micron accuracy. Thus, even a small disturbance force can result in a significant displacement of the tissue block. Therefore, the instant system relies upon an active restorative force to maintain the relative location of the tissue chuck 50 (or the tissue block) relative to the blade 55. In some embodiments, to counter potential displacement issues, the instant system can include one or more sensors on the microtome 104 itself that enable a closed loop control to determine where the chuck 50 is.

In some embodiments, the control system is configured to preserve a knowledge of a location of the surface (i.e. the blockface) of the tissue block after each cut with the blade 55. In particular, if each cut is 4 μm thick, the tissue block needs to be moved forward 4 μm over the blade 55 so that a tissue section at 4 μm can be cut. The control sample would track the reference (or prior) location of the blockface, to help it determine a desired movement of the tissue block.

In some embodiments, a blade clamping mechanism on the blade holder 60 can include a series of elastic actuators to secure the blade 55 in place. The series of elastic actuators can provide for a reference displacement of the clamping mechanism and can be used as a surrogate for force measurement. This way the blade clamping can have a consistent, or repeatable, clamping force between each blade change. As shown in FIG. 2D, the present system can include blade clamp, or clamping plate, 90, that can include a series of elastic actuators. In this case, a lever arm 84 can rotate to allow the blade clamp 90 to flex. The lever arm 84 can, in some embodiments, rotate a cam shaft that may be attached to the blade clamp 90. The blade clamp 90 can hold the blade 55 in place. For example, the clamp 90 can affect the relative location of the blade 55 so that the system may be focused on ensuring the relative position of the blade 55 relative to the tissue chuck 50 (or tissue block). By changing the rotational displacement of the lever 84, one can adjust the force applied by the clamp 90 on the blade 55. The lever arm 84 can be attached to an automated actuator to allow for automatic clamping of the blade 55.

In some embodiments, blade clamp 90 is a compliant plate. When mechanically connected, the lever 84 is rotated so the blade clamp 90 presses on the blade 55. In some embodiments, the blade clamp 90 can be a steel plate and its natural structure would provide the compliance. In some embodiments, the blade clamp 90 could be a composite structure, where the blade clamp 90 is very stiff in the direction where it presses on the blade 55 and is very compliant in the orthogonal direction. This anisotropic structure could dissipate vibrations using more elastic materials along the long axis of the blade 55 and transfer large forces to clamp the blade 55 in place repeatably at the same time. In reference to FIG. 2I, the vertical bars 91 represent the higher strength fibers and the background matrix so that the blade plate 90 can dissipate vibrations, in particular, higher frequency vibrations. By consistently providing clamping forces on the blade 55 and being able to dissipate vibrations, the blade clamp 90 is able to reduce or eliminate errors in tissue section thickness that are the result of inconsistent blade 55 clamping or positioning.

In some embodiments, an optical system can be used to determine the position of the tissue block, or the chuck 50, relative to the blade 55 of the microtome 104. In some embodiments, one or more imaging devices may be provided to take images from multiple locations to get distance information between the block surface, or the chuck 50, and the blade 55. Referring to FIG. 2D, in some embodiments, the cameras 87 could be placed on the chuck 50. In some embodiments, these one or more imaging devices may include a high-speed camera. In some embodiments, the one or more imaging devices have sufficient resolution such that the distance of the blade 55 to tissue block, or chuck 50, can be resolved to less than 10 μm.

While embodiments have been described herein in which the blade 55 is substantially stationary in the axial and vertical directions, and the axial and vertical position of the chuck 50 is adjusted to alter the relative positioning of the chuck 50 and the blade 55, it should be appreciated that embodiments are, also, contemplated herein where the position of the blade 55 is adjustable in axial and/or vertical directions instead of or in addition to the chuck 50 in order to change the relative positioning of the chuck 50 and the blade 55.

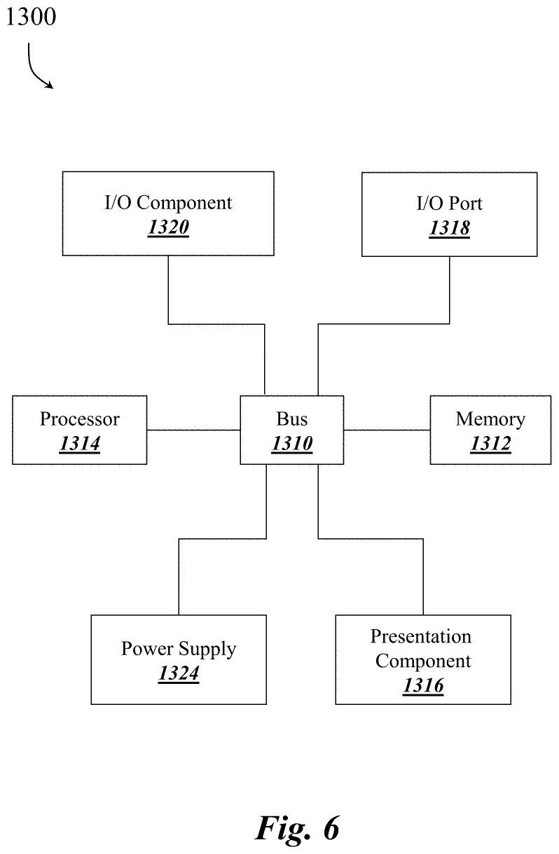

Any suitable computing device can be used to implement the computing devices and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 1300 is depicted in FIG. 6. The computing device 1300 is merely an illustrative example of a suitable computing environment and in no way limits the scope of the present disclosure. A “computing device,” as represented by FIG. 6, can include a “workstation,” a “server,” a “laptop,” a “desktop,” a “hand-held device,” a “mobile device,” a “tablet computer,” or other computing devices, as would be understood by those of skill in the art. Given that the computing device 1300 is depicted for illustrative purposes, embodiments of the present disclosure may utilize any number of computing devices 1300 in any number of different ways to implement a single embodiment of the present disclosure. Accordingly, embodiments of the present disclosure are not limited to a single computing device 1300, as would be appreciated by one with skill in the art, nor are they limited to a single type of implementation or configuration of the example computing device 1300.

The computing device 1300 can include a bus 1310 that can be coupled to one or more of the following illustrative components, directly or indirectly: a memory 1312, one or more processors 1314, one or more presentation components 1316, input/output ports 1318, input/output components 1320, and a power supply 1324. One of skill in the art will appreciate that the bus 1310 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 6 is merely illustrative of an exemplary computing device that can be used to implement one or more embodiments of the present disclosure, and in no way limits the disclosure.

The computing device 1300 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 1300.

The memory 1312 can include computer-storage media in the form of volatile and/or nonvolatile memory. The memory 1312 may be removable, non-removable, or any combination thereof. Exemplary hardware devices are devices such as hard drives, solid-state memory, optical-disc drives, and the like. The computing device 1300 can include one or more processors that read data from components such as the memory 1312, the various I/O components 1316, etc. Presentation component(s) 1316 present data indications to a user or other device. Exemplary presentation components include a display device, speaker, printing component, vibrating component, etc. The computing device 1300 can include one or more processors 1304 configured to execute instructions encoded on at least one non-transitory computer-readable storage medium. Execution of the instructions encoded on the at least one non-transitory computer-readable storage medium can cause the one or more processors 1304 to carry out one or more above the above-described methods.

The I/O ports 1318 can enable the computing device 1300 to be logically coupled to other devices, such as I/O components 1320. Some of the I/O components 1320 can be built into the computing device 1300. Examples of such I/O components 1320 include a microphone, joystick, recording device, game pad, satellite dish, scanner, printer, wireless device, networking device, and the like.

In some aspects, the present disclosure provides a microtomy system for controlling tissue section thickness, the microtomy system including, a tissue chuck configured to accept a tissue block including a tissue sample embedded in an embedding material; a microtome blade configured to remove one or more tissue sections from the tissue block, the microtome blade being axially offset from the tissue chuck a distance, wherein the microtome blade and the tissue chuck are axially displaceable relative to one another; and a control system configured for determining an axial location of a surface of the tissue block or the tissue chuck relative to an axial location of the microtome blade, and to use a control loop to control a thickness of the one or more tissue sections as a function of a relative axial location of the microtome blade to the tissue chuck. In some aspects, the control system is configured to preserve a knowledge of a location of a surface of the tissue block after each cut with the microtome blade. In some aspects, the microtomy system further includes a tissue transfer medium configured to be attached to a blockface of the tissue block, disposed in the tissue chuck, prior to a cutting function with the microtome blade, wherein the control system is configured to maintain the tissue section thickness after application of an engagement of the tissue transfer medium. In some aspects, the microtomy system further includes position sensors configured to determine the axial location of the tissue chuck relative to the axial location of the microtome blade, and actuators configured to correct the axial location of the tissue chuck. In some aspects, the control system further includes a position sensor to measure the axial location of the tissue chuck and the axial location of the microtome blade. In some aspects, the microtomy system further includes an axial actuator disposed on the tissue chuck to axially displace the tissue chuck, wherein the control system is configured to actuate the axial actuator to displace the tissue chuck as a function of the relative axial location of the microtome blade to the tissue chuck. In some aspects, the microtomy system further includes one or more rotatory actuators to control the orientation of the tissue block around a vertical and a horizontal axis to align a surface plane of the tissue block with a defined by the microtome blade and a vertical tissue block motion axis. In some aspects, the microtomy system further includes further includes a series of elastic actuators for actuating a blade clamp to clamp the microtome blade such that a clamping force against the blade clamp is repeatable between microtome blade exchanges. In some aspects, the microtomy system can include a series of elastic actuators for clamping the microtome blade so that a force on the microtome blade and a position of the microtome blade is controlled. In some aspects the microtomy system can include a series of elastic actuators for clamping the microtome blade that has an anisotropic structure so that it can provide high clamping forces on the blade and conform to an opposing clamping plate-blade system in another direction while dissipating energy to passively control vibrations of the blade.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification, embodiments have been described in a way which enables a clear and concise specification to be written, but it is intended and will be appreciated that embodiments may be variously combined or separated without parting from the scope of the present disclosure. It is intended that the present disclosure be limited only to the extent required by the appended claims and the applicable rules of law.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the disclosure. It is intended that the present disclosure be limited only to the extent required by the appended claims and the applicable rules of law.

It is also to be understood that the following claims are to cover all generic and specific features of the disclosure described herein, and all statements of the scope of the disclosure which, as a matter of language, might be said to fall therebetween.

1. A microtomy system comprising:
a tissue chuck configured to accept a tissue block;
a microtome blade configured to remove one or more tissue sections from the tissue block, the microtome blade being axially offset from the tissue chuck along a horizontal axis, wherein the microtome blade and the tissue chuck are axially displaceable relative to one another along the horizontal axis; and
a control system configured to receive information indicative of a relative axial location of the microtome blade to the tissue chuck along the horizontal axis, and to use a control loop to control the relative axial location of the microtome blade to the tissue chuck such that the one or more tissue sections have a desired thickness.

2. The microtomy system of claim 1 further comprising:
one or more position sensors configured to collect information indicative of the relative axial location of the microtome blade to the tissue chuck and to communicate the relative axial location to the control system; and
an actuator, in communication with the control system, configured to displace the tissue chuck along the horizontal axis.

3. The microtomy system of claim 1, wherein the control system further includes one or more position sensors to measure an axial location of the tissue chuck and an axial location of the microtome blade along the horizontal axis.

4. The microtomy system of claim 1 further comprising:
an axial actuator coupled the tissue chuck to axially displace the tissue chuck,
wherein the control system is configured to actuate the axial actuator to displace the tissue chuck as a function of the relative axial location of the microtome blade to the tissue chuck.

5. The microtomy system of claim 1 further comprising:
a series of elastic actuators for clamping the microtome blade that has an anisotropic structure so that it can provide high clamping forces on the microtome blade and conform to an opposing clamping plate-blade system in another direction while dissipating energy to passively control vibrations of the microtome blade.

6. The microtomy system of claim 5 further comprising:
one or more force sensors configured to collect information indicative of the relative axial location of the microtome blade to the tissue chuck and to communicate the relative axial location to the control system; and
an actuator, in communication with the control system, configured to displace the tissue chuck along the horizontal axis.

7. The microtomy system of claim 1 further comprising one or more force sensors positioned on the tissue chuck and configured to determine a force applied to the tissue block from the microtome blade.

8. The microtomy system of claim 1, wherein the information indicative of the relative axial location is a force applied to the tissue block from the microtome blade.

9. The microtomy system of claim 1, further comprising an actuator, in communication with the control system, configured to displace the tissue chuck along a vertical axis.

10. The microtomy system of claim 9, wherein the actuator is coupled to a leadscrew via a non-rigid system configured to decouple the leadscrew from the actuator.

11. The microtomy system of claim 1, further comprising an actuator, in communication with the control system, configured to displace the tissue chuck along the horizontal axis, wherein the control loop controls the actuator to displace the tissue chuck along the horizontal axis such that the one or more tissue sections have a desired thickness.

12. The microtomy system of claim 1, further comprising an actuator, in communication with the control system, configured to displace the tissue chuck along a vertical axis, wherein the control loop controls the actuator to displace the tissue chuck along the vertical axis such that the one or more tissue sections have a desired thickness.

13. The microtomy system of claim 1, further comprising:
a first actuator, in communication with the control system, configured to displace the tissue chuck along the horizontal axis; and
a second actuator, in communication with the control system, configured to displace the tissue chuck along a vertical axis, wherein the control loop controls the first actuator to displace the tissue chuck along the horizontal axis and the second actuator to displace the tissue chuck along the vertical axis such that the one or more tissue sections have a desired thickness.

14. The microtomy system of claim 1 further comprising:
a first actuator, in communication with the control system, configured to displace the tissue chuck along a vertical axis; and
a second actuator, in communication with the control system, configured to displace the tissue chuck along the horizontal axis.

15. A control system, comprising:
at least one non-transitory computer-readable storage medium having encoded thereon executable instructions that, when executed by at least one processor, cause the at least one processor to carry out a method comprising:
receiving information indicative of a relative axial location of a microtome blade to a tissue chuck along a horizontal axis, wherein:
the microtome blade is configured to remove one or more tissue sections from a tissue block accepted in the tissue chuck; and
the microtome blade and the tissue chuck are axially displaceable relative to one another along the horizontal axis; and
using a control loop to control the relative axial location of the microtome blade to the tissue chuck such that the one or more tissue sections have a desired thickness.

16. The control system of claim 15, wherein the method further comprises:
receiving the relative axial location of the microtome blade to the tissue chuck from one or more position sensors configure to collect information indicative of the relative axial location; and
controlling an actuator to displace the tissue chuck along the horizontal axis.

17. The control system of claim 16, wherein the one or more position sensors are configured to measure an axial location of the tissue chuck and an axial location of the microtome blade along the horizontal axis.

18. The control system of claim 15, wherein the method further comprises actuating an axial actuator coupled to the tissue chuck to displace the tissue chuck as a function of the relative axial location of the microtome blade to the tissue chuck.

19-23. (canceled)

24. A microtomy system, comprising:
one or more position sensors configured to collect information indicative of a relative axial location along a horizontal axis of a microtome blade to a tissue chuck, wherein:
the microtome blade is configured to remove one or more tissue sections from a tissue block, the microtome blade being axially offset from the tissue chuck along the horizontal axis; and
the microtome blade and the tissue chuck are axially displaceable relative to one another along the horizontal axis; and
a control system configured to receive information indicative of a relative axial location of the microtome blade to the tissue chuck along the horizontal axis, and to use a control loop to control the relative axial location of the microtome blade to the tissue chuck such that the one or more tissue sections have a desired thickness.

25-36. (canceled)

37. A microtomy system for controlling tissue section thickness, the microtomy system comprising:
a tissue chuck configured to accept a tissue block;
a microtome blade configured to remove one or more tissue sections from the tissue block, the microtome blade being axially offset from the tissue chuck along a horizontal axis, wherein the microtome blade and the tissue chuck are axially displaceable relative to one another along the horizontal axis;
one or more sensors configured to collect information indicative of a relative axial location along the horizontal axis of the microtome blade to the tissue chuck;
an actuator configured to displace the tissue chuck along the horizontal axis; and
a control system configured to receive information indicative of a relative axial location of the microtome blade to the tissue chuck along the horizontal axis, and to use a control loop to control the relative axial location of the microtome blade to the tissue chuck such that the one or more tissue sections have a desired thickness.

38-48. (canceled)
